(19) United States
(12) Patent Application Publication
(10) Pub. No.: US 2017/0336264 A1
(43) Pub. Date: Nov. 23, 2017

(54) OPTOELECTRONIC DEVICE FOR MULTI-SPECTRAL SPECTROSCOPIC IDENTIFICATION OF THE POLYMER COMPOSITION OF AN UNKNOWN PLASTIC OBJECT AND RELATED METHODS

(71) Applicant: UNIVERSITY OF CENTRAL FLORIDA RESEARCH FOUNDATION, INC., Orlando, FL (US)

(72) Inventors: Debashis CHANDA, Oviedo, FL (US); Abraham VAZQUEZ-GUARDADO, Orlando, FL (US)

(21) Appl. No.: 15/597,259

(22) Filed: May 17, 2017

Related U.S. Application Data
(60) Provisional application No. 62/337,390, filed on May 17, 2016.

(51) Int. Cl. G01J 3/457; B29B 17/02; G01N 21/27; G01N 21/17

(52) U.S. Cl. CPC G01J 3/457; G01N 21/27; B29B 17/02; B29B 2017/0203; G01N 2021/1748; B29B 2017/0279

(57) ABSTRACT

An electronic device is for identifying the plastic composition of an unknown plastic object. The electronic device may include a spectrometer configured to receive the unknown plastic object and generate a MIR reflectance spectra characteristic of the unknown plastic object, a memory configured to store a multi-spectral fingerprint library for plastic types, and a processor coupled to the spectrometer and the memory. The processor is configured to analyze in real-time the MIR reflectance spectra characteristic of the unknown plastic object, and identify the plastic composition based upon at least comparing the MIR reflectance spectra characteristic of the unknown plastic object to the multi-spectral fingerprint library. The processor may be configured to expand the fingerprint library upon initial baseline characterization.

### RELATED APPLICATION

This application is based upon prior filed copending U.S. Application No. 62/337,390 filed May 17, 2016, the entire subject matter of which is incorporated herein by reference in its entirety.

### GOVERNMENT RIGHTS

This invention was made with government support under contract number 63019022 awarded by National Aeronautics and Space Administration. The government has certain rights in the invention.

### TECHNICAL FIELD

The present disclosure relates to the field of spectroscopy, and, more particularly, to a device for plastic waste identification and sorting with spectroscopy and related methods.

### BACKGROUND

Waste management for recycling is one of the most important needed tasks in order to save the world from the immense quantity of solid waste being disposed every day [1]. In 2012, approximately 251 million tons of solid waste was generated in the USA alone, where 13% of it was different kinds of plastics. However, out of the 87 million tons of recovered solid waste, only a total of 3% corresponded to plastics, and the remaining portion was dumped into landfills, making plastic one of the major environmental pollutants [2]. Hence, a large-scale effort is still needed in order to increase the plastic recycling outcome.

An important issue plastic recycling facilities must overcome is the accurate identification and sorting of plastic materials ingested into the facility. In fact, some plastic types may not be recyclable at the facility and could present downstream problems if they are not removed. One approach to this issue is disclosed in U.S. Pat. No. 6,313,423 to Sommer et al. This system is for sorting a plurality of waste products by polymer type. The system uses Raman spectroscopy and identification techniques to identify and sort post-consumer plastics for recycling.

### SUMMARY

Generally speaking, an electronic device is for identifying the plastic composition of an unknown plastic object. The electronic device may include a spectrometer configured to receive the unknown plastic object and generate at least one mid-infrared (MIR) reflectance spectra characteristic of the unknown plastic object, a memory configured to store a multi-spectral fingerprint library for a plurality of plastic types, and a processor coupled to the spectrometer and the memory. The processor may be configured to analyze in real-time the at least one MIR reflectance spectra characteristic of the unknown plastic object, and identify the plastic composition based upon comparing the at least one MIR reflectance spectra characteristic of the unknown plastic object to the multi-spectral fingerprint library.

In particular, the processor may be configured to identify the plastic composition when the at least one MIR reflectance spectra characteristic of the unknown plastic object matches a respective reflectance spectra characteristic in the multi-spectral fingerprint library. The electronic device may comprise an infrared source (e.g. tungsten filament source and/or a globar source) configured to irradiate the unknown plastic object.

In some embodiments, each reflectance spectra characteristic in the multi-spectral fingerprint library may comprise at least one spectral peak and at least one spectral valley associated with a particular vibrational absorption resonance. Each reflectance spectra characteristic in the multi-spectral fingerprint library may also comprise at least one standard deviation value for the at least one spectral peak and the at least one spectral valley. The processor may be configured to identify the plastic composition when the at least one MIR reflectance spectra characteristic of the unknown plastic object matches each spectral peak and spectral valley of a respective reflectance spectra characteristic in the multi-spectral fingerprint library. For example, the plurality of plastic types may comprise Polyethylene Terephthalate (PET), High Density Polyethylene (HDPE), Polyvinyl Chloride (PVC), Low Density Polyethylene (LDPE), Polypropylene (PP), Polystyrene (PS), Polycarbonate (PC), Acrylic, Nylon, Polyoxymethylene (POM), Acrylonitrile Butadiene Styrene (ABS), and Polytetrafluoroethylene (PTFE).

Another aspect is directed to a method for identifying the plastic composition of an unknown plastic object. The method may comprise operating a spectrometer to receive the unknown plastic object and generate at least one MIR reflectance spectra characteristic of the unknown plastic object, and operating a memory to store a multi-spectral fingerprint library for a plurality of plastic types. The method may comprise operating a processor coupled to the spectrometer and the memory and to analyze in real-time the at least one MIR reflectance spectra characteristic of the unknown plastic object, and identify the plastic composition based, but not limited to, upon comparing the at least one MIR reflectance spectra characteristic of the unknown plastic object to the multi-spectral fingerprint library.

### BRIEF DESCRIPTION OF THE DRAWINGS

FIG. 1 is a table of analyzed plastic resin families, according to the present disclosure.

FIGS. 2A-2B show the reflectance reference spectra for the near-infrared (NIR) and MIR domain, respectively, and the multi-spectral fingerprint selection method (shown as arrows), according to the present disclosure.

FIGS. 3A-3B are the normalized reflectance spectra for different plastics in the NIR domain, according to the present disclosure.

FIGS. 4A-4D are the NIR reflectance spectra of several colored examples of plastic, according to the present disclosure.

FIGS. 5A-5B are the MIR reflectance spectra for different plastics, according to the present disclosure.

FIG. 6 is the reflectance spectra of PS in foam (PS-f) and solid (PS-s) phases, according to the present disclosure.

FIGS. 7A-7D are the MIR reflectance of several colored examples of plastic, according to the present disclosure.

FIG. 8 is a table of the multi-spectral fingerprint of the 12 plastic resin groups in the NIR and MIR, according to the present disclosure.

FIGS. 9A-9B are the picture of the plastic samples randomly selected for blind identification, according to the present disclosure.

FIGS. 10A-10B are the reflectance spectra of all PET samples characterized in the NIR and MIR spectral domains, respectively, according to the present disclosure.

FIGS. 11A-11B are the reflectance spectra of all HDPE samples characterized in the NIR and MIR spectral domains, respectively, according to the present disclosure.

FIGS. 12A-12B are the reflectance spectra of all PVC samples characterized in the NIR and MIR spectral domains, respectively, according to the present disclosure.

FIGS. 13A-13B are the reflectance spectra of all LDPE samples characterized in the NIR and MIR spectral domains, respectively, according to the present disclosure.

FIGS. 14A-14B are the reflectance spectra of all PP samples characterized in the NIR and MIR spectral domains, respectively, according to the present disclosure.

FIGS. 15A-15B are the reflectance spectra of all PS in solid phase samples characterized in the NIR and MIR spectral domains, respectively, according to the present disclosure.

FIGS. 16A-16B are the reflectance spectra of all PS in foam phase samples characterized in the NIR and MIR spectral domains, respectively, according to the present disclosure.

FIGS. 17A-17B are the reflectance spectra of all PC samples characterized in the NIR and MIR spectral domains, respectively, according to the present disclosure.

FIGS. 18A-18B are the reflectance spectra of all acrylic samples characterized in the NIR and MIR spectral domains, respectively, according to the present disclosure.

FIGS. 19A-19B are the reflectance spectra of all nylon samples characterized in the NIR and MIR spectral domains, respectively, according to the present disclosure.

FIGS. 20A-20B are the reflectance spectra of all POM samples characterized in the NIR and MIR spectral domains, respectively, according to the present disclosure.

FIGS. 21A-21B are the reflectance spectra of all ABS samples characterized in the NIR and MIR spectral domains, respectively, according to the present disclosure.

FIGS. 22A-22B are the reflectance spectra of all PTFE samples characterized in the NIR and MIR spectral domains, respectively, according to the present disclosure.

FIG. 23 is a schematic block diagram of the electronic device, according to the present disclosure.

FIG. 24 is a schematic block diagram of another embodiment of the electronic device, according to the present disclosure.

### DETAILED DESCRIPTION

The present disclosure will now be described in more details hereinafter with reference to the accompanying drawings, in which several embodiments of the present disclosure are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

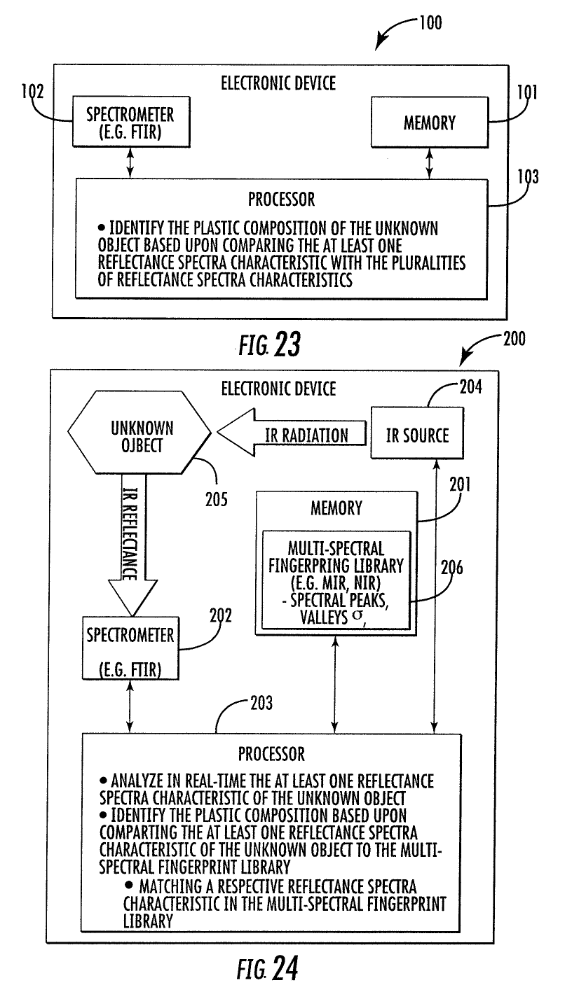

Referring initially and briefly to FIG. 23, an optical device 100 for identifying the plastic composition of an unknown object is now described. The optical device 100 illustratively includes a spectrometer (e.g. Fourier transform infrared (FTIR) spectrometer) 102 properly configured to receive the unknown object and generate at least one reflectance spectra (e.g. MIR, NIR) characteristic of the unknown object, and a memory 101 configured to store a database comprising of a multi-spectral fingerprint library of several plastic types. The optoelectronic device 100 illustratively includes a processor 103 programed to perform real-time data analysis and identification of the plastic composition of the unknown object based upon, but not limited to, comparing the acquired spectral fingerprint to that of the multi-spectral fingerprint library. The library of plastic types may comprise, for example, PET, HDPE, PVC, LDPE, PP, PS, PC, Acrylic, Nylon, POM, ABS, and PTFE. However, it is not solely limited to the aforementioned group but to many others with or without fillers or modifiers, which can be straightforwardly added to the library upon initial baseline characterization.

Another aspect is directed to a method for identifying the plastic composition of an unknown object. The method may include operating a spectrometer 102 to receive the unknown object and generate at least one MIR reflectance spectra characteristic of the unknown object, and operating a memory 101 to store a multi-spectral fingerprint library of several plastics. The method may include operating a processor 103 to identify the plastic composition of the unknown object in real-time based upon, but not limited to, comparing the fingerprint extracted from the reflectance spectra with the multi-spectral fingerprint library.

In the polymer recycling industry, resin identification is the most important step in order to guarantee the economical worthiness of the process since cross contamination of incompatible resins can degrade the quality of the entire recycled batch. Moreover, this task may be challenging due to the large diversity of plastics present in the recovered plastic stocks from municipal waste, which mandates accurate classification before entering the recycling chain [3,4].

To identify and sort different families of plastics, techniques such as triboeletrostatic separation based on the electrostatic charge of a known plastic mixture [5-7], magnetic density [8,9], air flotation [10], automated image analysis systems to discriminate plastic bottles of a specific plastic resin [11], and some combination of these [12,13] have been developed. These methods use prior knowledge of the material's physical properties for external stimulus-based detection. Likewise, all of these methods may work well in a known material stock but may fail in a realistic scenario of blind identification of an unknown combination of plastics.

In order to tackle this crucial step in the recycling chain, accurate identification of plastics based on chemical composition is very important, as pointed out earlier. For this purpose, various methods such as FTIR spectroscopy [14,15], Raman spectroscopy [16], direct chemical element identification based on laser-induced breakdown spectroscopy [17,18], and hyperspectral imaging methods [8,19,20] have been studied. These methods have proven to be reliable in identifying unique molecular vibrational finger-prints in polymer compounds [21], especially NIR Fourier transform infrared spectroscopy (FTIR) spectroscopy for its robustness and flexibility.

FTIR spectroscopy techniques vary between different configurations such as transmission, absorption, or reflection, which is restricted by the application needs or the sample preparation method, but the underlying physics involved in the detection remain the same. In fact, by measuring reflectance spectra one can straightforwardly estimate the absorption coefficients by performing the Kramers-Kronig transformation [21-23]. The spectral domain is dictated by the dominant vibrational modes present in those spectral bands. However, unique identification is challenging due to the weaker spectral features that are further overlapped in frequency among various plastics due to similar vibrational mode overtones generated by the main functional groups. Vibrational mode overtones of the functional groups, mainly XH, XH₂, and XH₃, (X═C, N, O, etc.), tend to be weaker in the NIR, but their fundamental modes are stronger in the MIR domain. In addition, some resonances are only present in the MIR domain for some polymers, rendering the NIR domain useless.

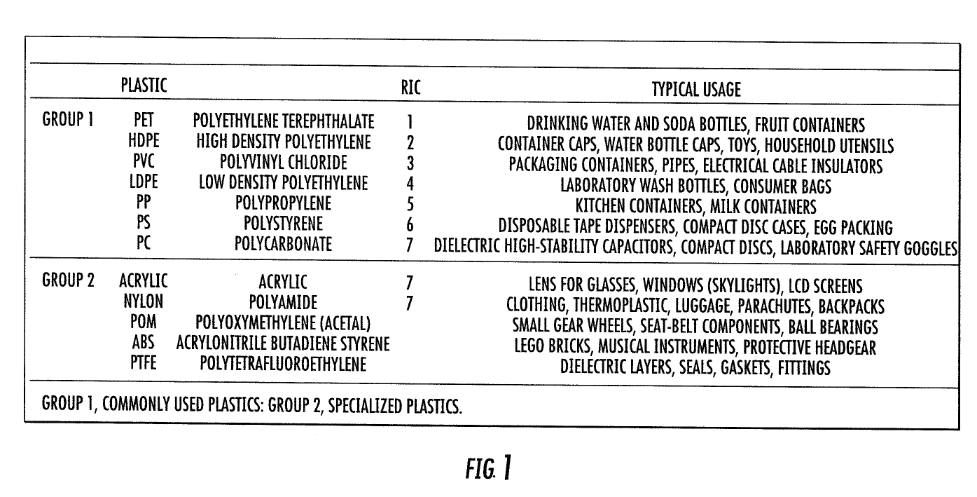

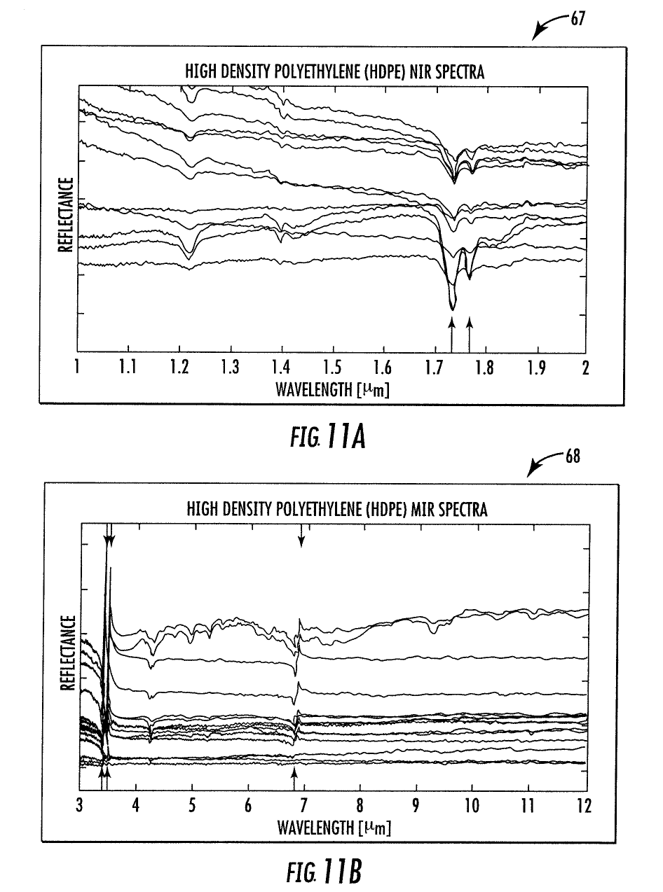

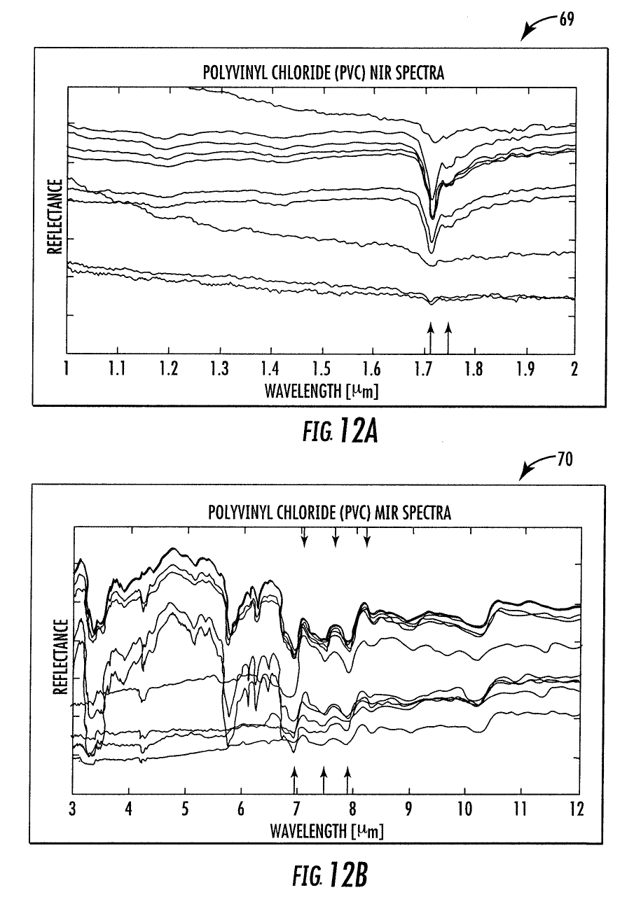

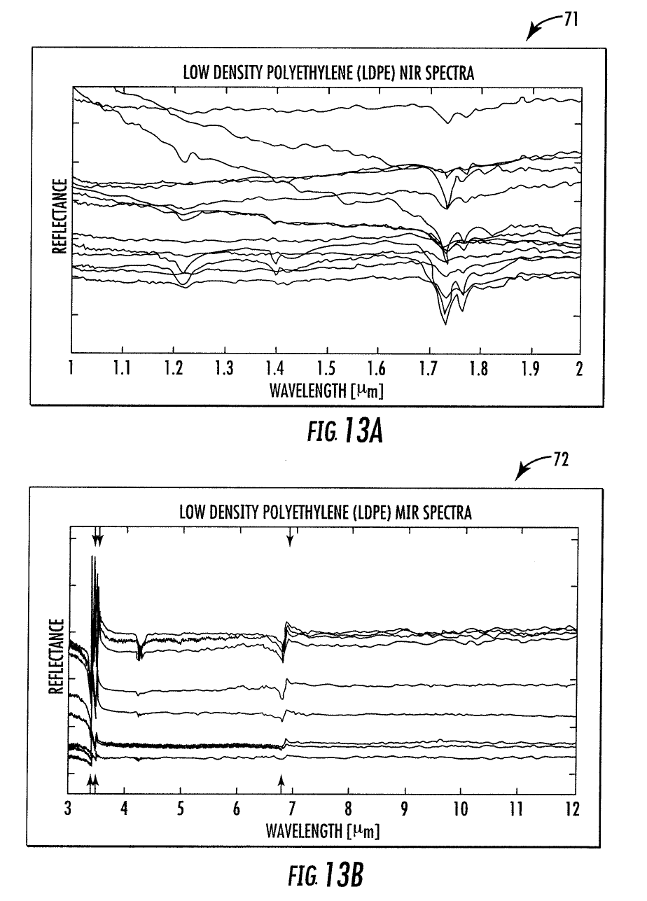

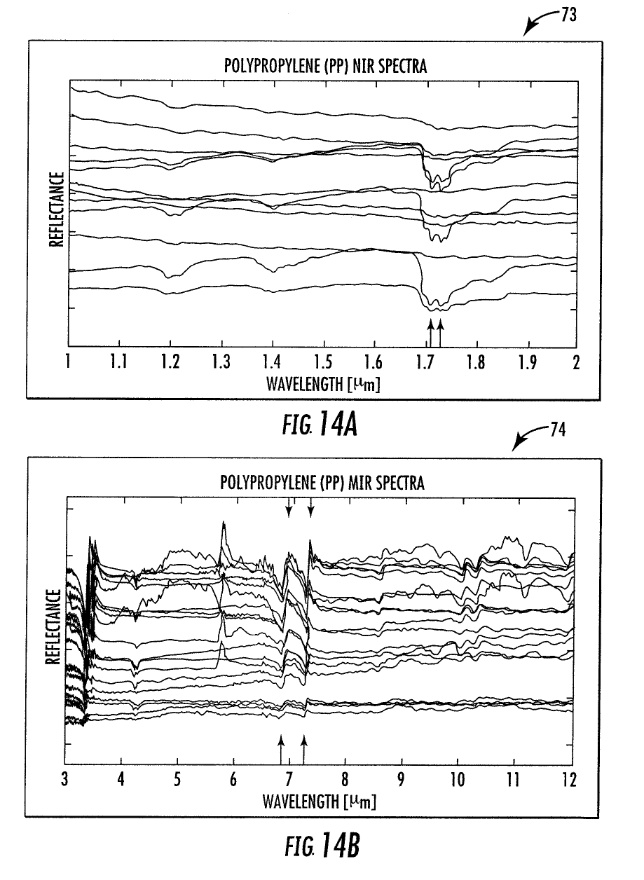

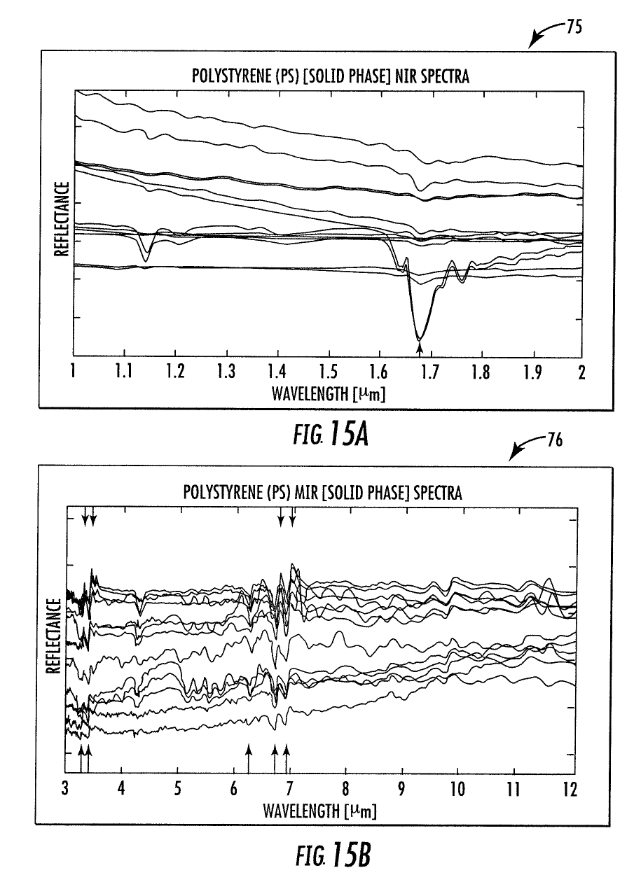

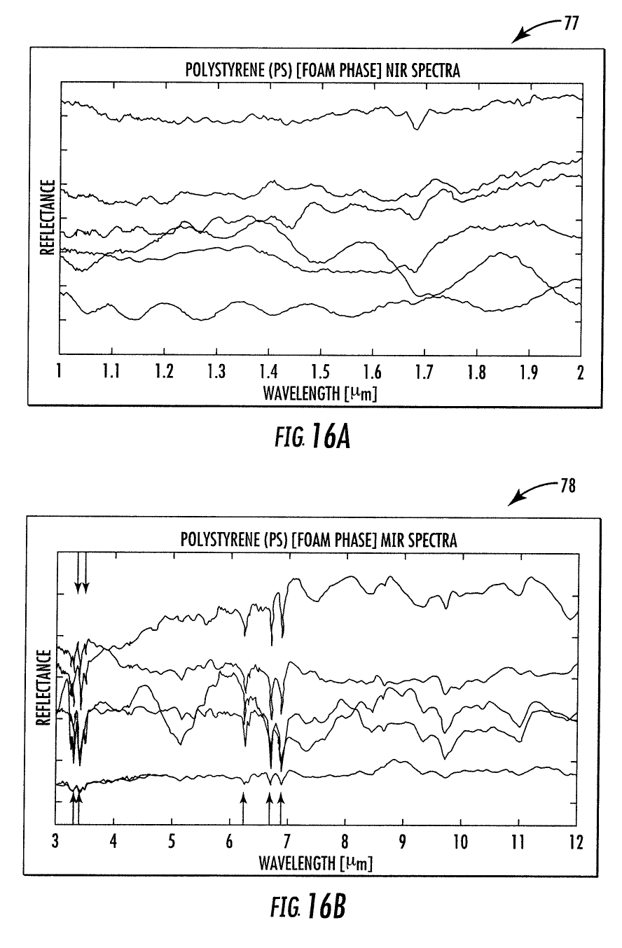

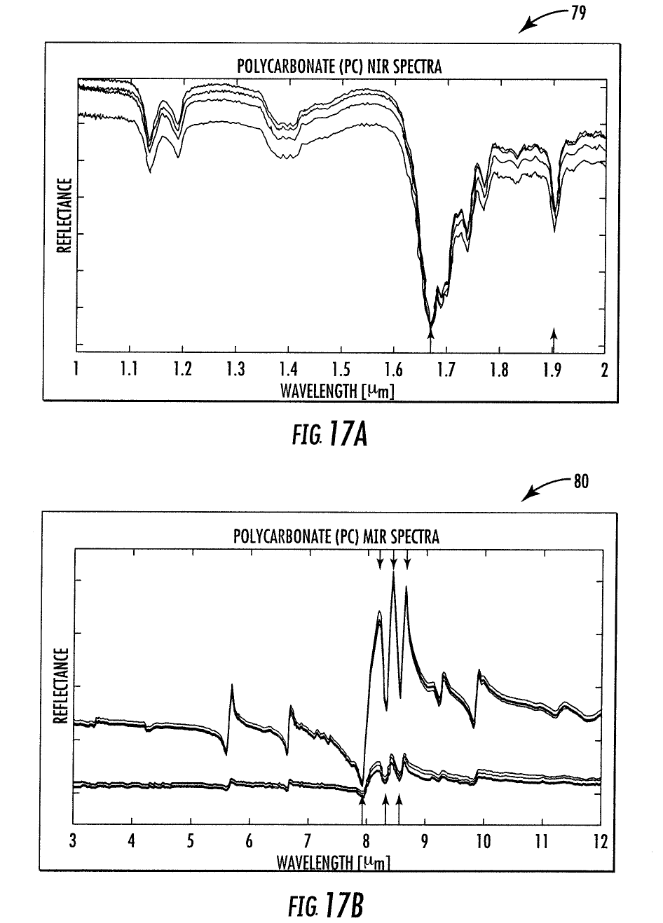

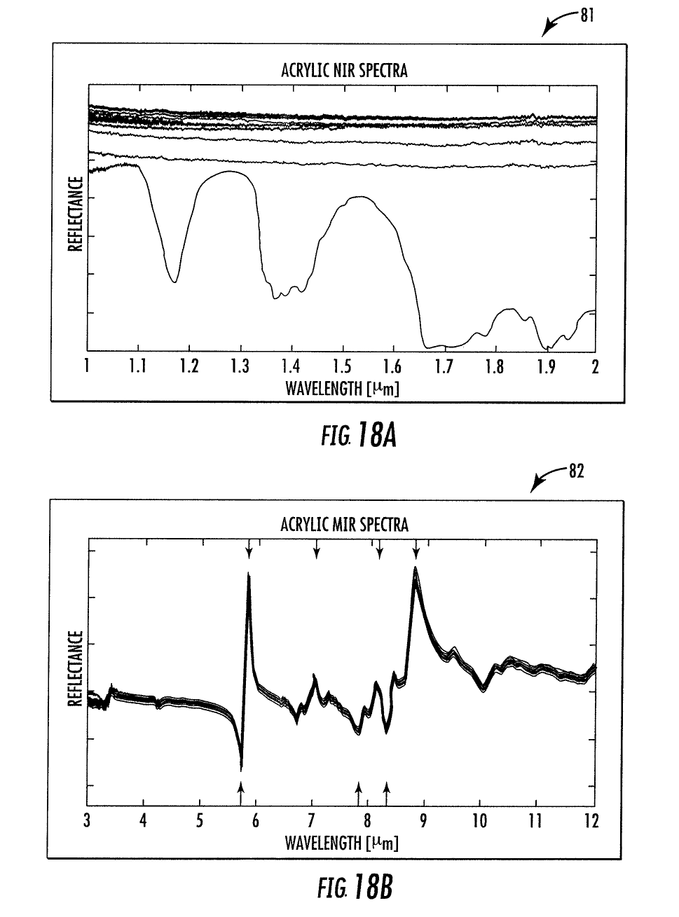

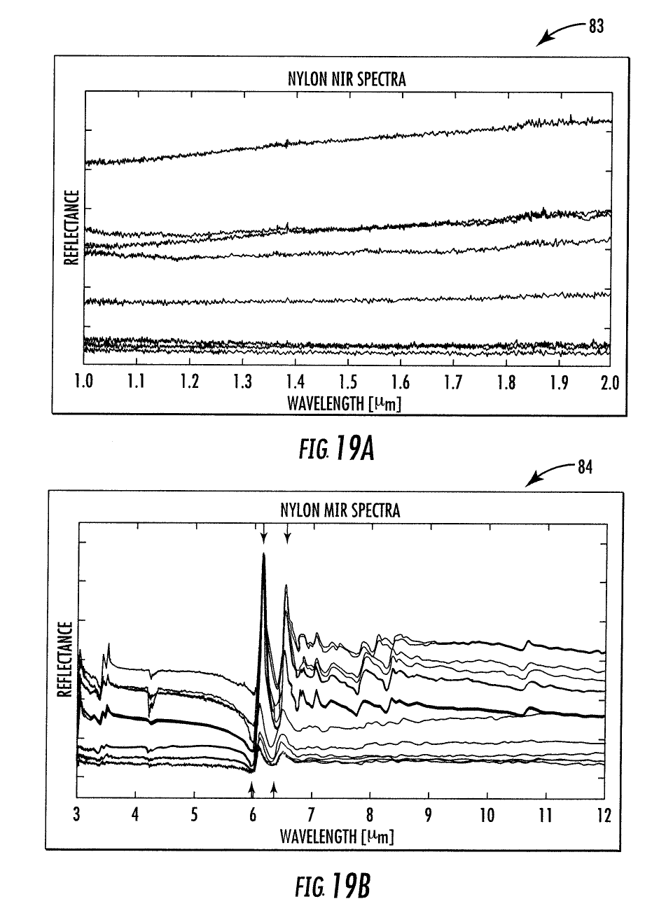

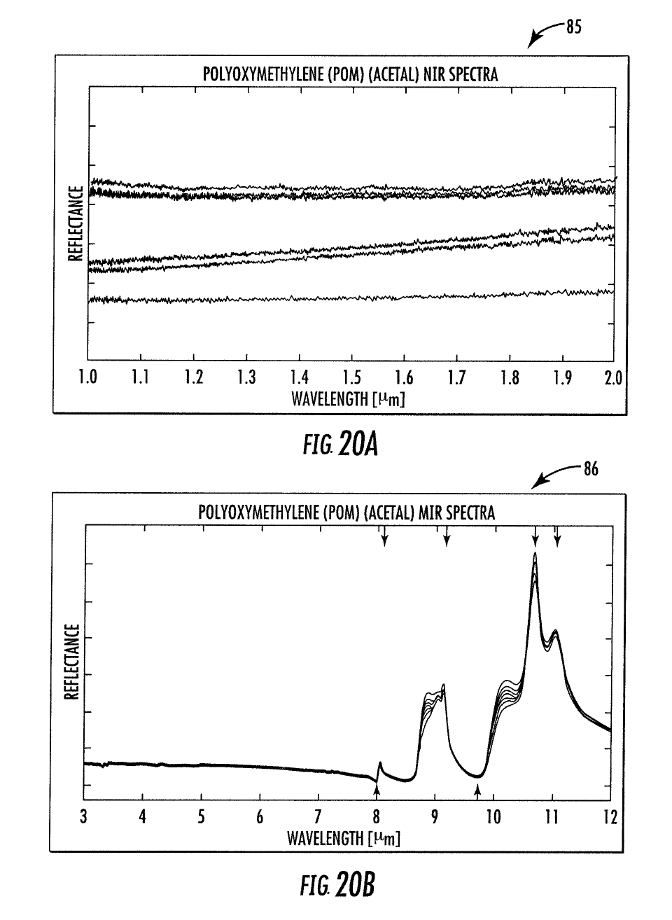

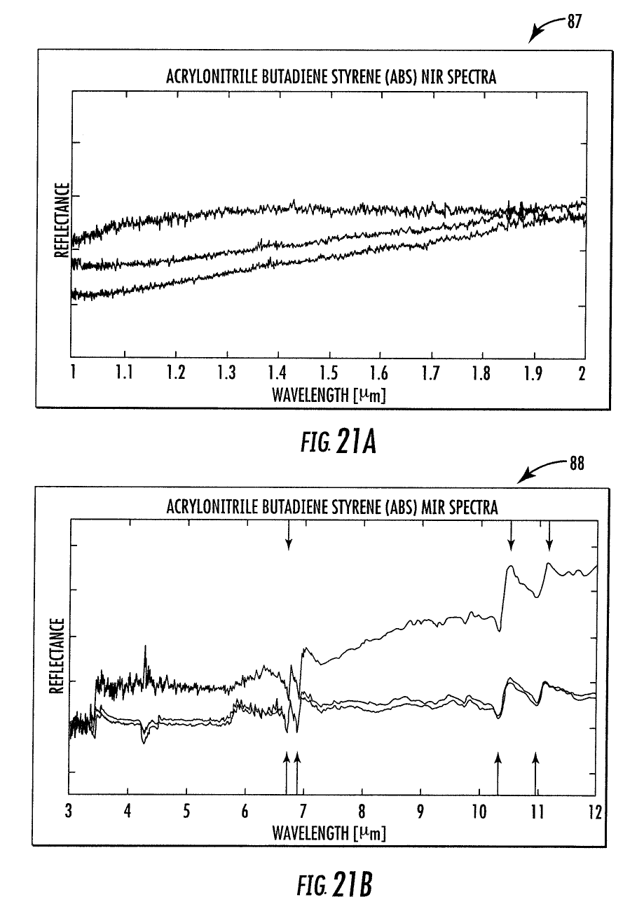

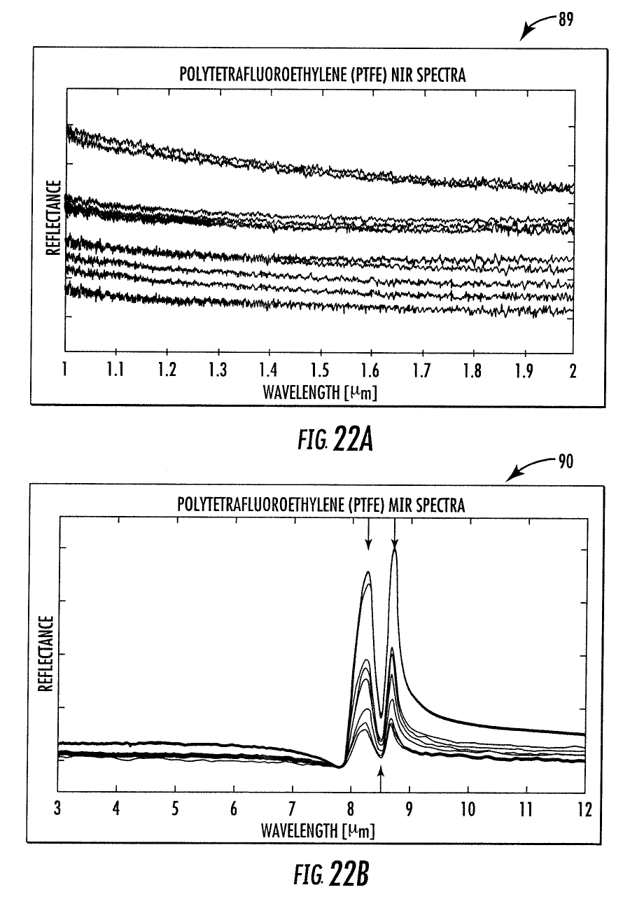

Referring now additionally to FIGS. 1-22B, a multi-spectral detection technique that covers both the NIR (1.5-2.0 μm) and the MIR (3-16 μm) spectral domains is described to capture unique vibrational overtones of commonly used as well as specialized plastics. Several multi-spectral reflectance features are statistically identified to create a unique combination of spectral features (unique multi-spectral finger-print). Apart from spectral features, an additional degree of freedom is added by distinguishing them by either valleys (v) or peaks (p) associated with their vibrational resonance modes. The reported multi-spectral and multi-dimensional fingerprint library can be used to identify almost all widely used plastic resin groups with almost 100% accuracy for the first time, to the best of our knowledge.

### Materials and Methods

A broad spectrum of plastics was collected in order to cover the diversified plastic items widely encountered in the municipal waste: 12 plastic resins were chosen and divided in two groups. The most common plastics are generated mainly from household and end consumer products and are grouped into group 1, labeled by the society of the plastic industry with a resin identification code (RIC). This group includes PET, HDPE, PVC, LDPE, PP, PS, and PC. In the collected samples, PS is found in two phases, foam (PS-f) and solid (PS-s), which showed clear distinction in their reflectance spectra. Another group of plastics are those that are encountered in more specialized applications but also contribute to the overall plastic waste and are grouped into group 2. These plastics are acrylic, nylon, Polyoxymethylene (POM i.e. Acetal), ABS, and PTFE. FIG. 1 lists all of these plastics, their associated commercial acronyms, their RIC, and their common end use application examples. While most plastics were collected using the RIC, others were directly purchased to guarantee the identity of the plastic resin. From each object, a small sample was trimmed (to fit in the spectrometer sample holder) and cleaned to remove residues. They were labeled and sorted as per their plastic resin constituent.

The reflectance spectra were acquired using a microscope-coupled FTIR spectrometer (Hyperion 1000-Vertex 80, as available from Bruker Optics, Inc. of Billerica, Mass.). The NIR reflectance spectra were measured using a tungsten filament source in combination with calcium fluoride beam splitter. The MIR reflectance spectra were measured with a glow bar thermal source paired with a potassium bromide beam splitter. In both configurations, a nitrogen cooled mercury cadmium telluride (MCT) detector and a 0.4 NA Cassegrain objective lens were used. The background reference was taken with respect to a gold mirror. The spectrometer spectral resolution was 4 cm⁻¹, and the reflectance spectra were averaged 128 times. Such spectrometer resolution maps to wavelength resolution (Δλ=λ²Δν, where λ is the wavelength of interest, Δν is the spectrometer resolution in wavenumbers, and Δλ is the corresponding resolution in wavelength) of 0.04 nm at 1 μm, 10 nm at 5 μm, and 40 nm at 10 μm, which are enough to resolve such broad vibrational resonances.

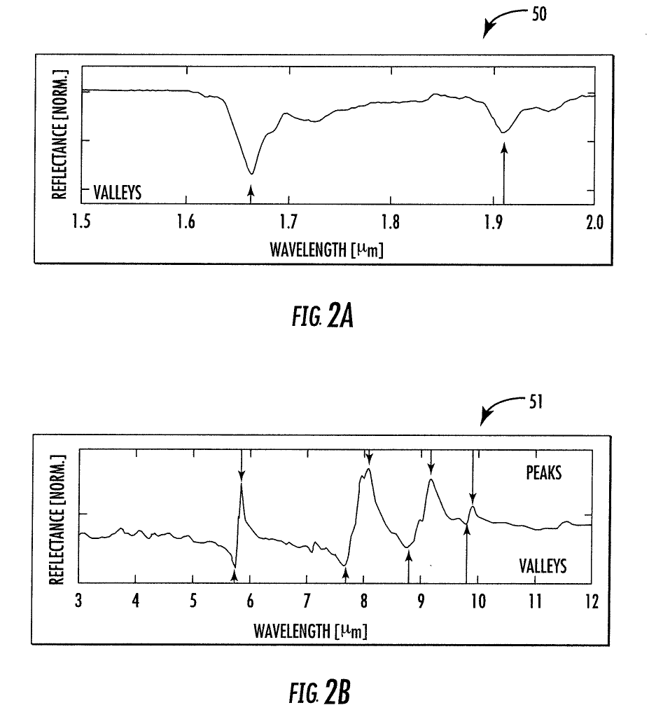

The reflectance of all plastic samples was collected to identify the dominant spectral features in both the NIR and MIR domains. An example of the spectral feature selection process is shown in FIGS. 2A-2B, which depicts the reflectance spectra for a PET film in the NIR (diagram 50, FIG. 2A) and the MIR (diagram 51, FIG. 2B) domains, indicating the selected dominant spectral features. Two measurements per sample were taken. The spectral library containing mean spectral feature values of peaks and valleys (λ_{p,v}) with its standard deviation (σ) of all plastics resin families is constructed. Finally, this library is used for database search for the blind detection of unknown plastic samples.

### Results: Near Infrared

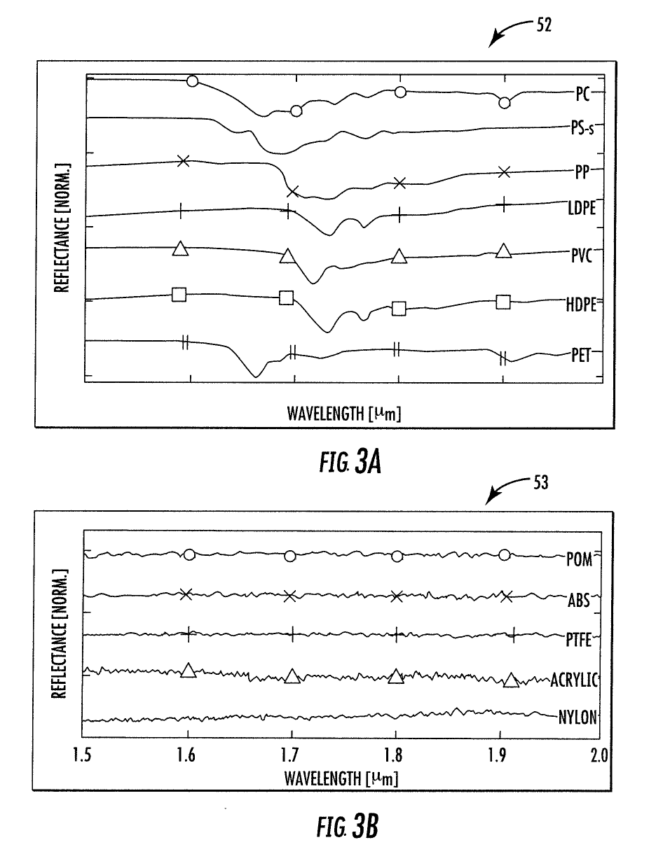

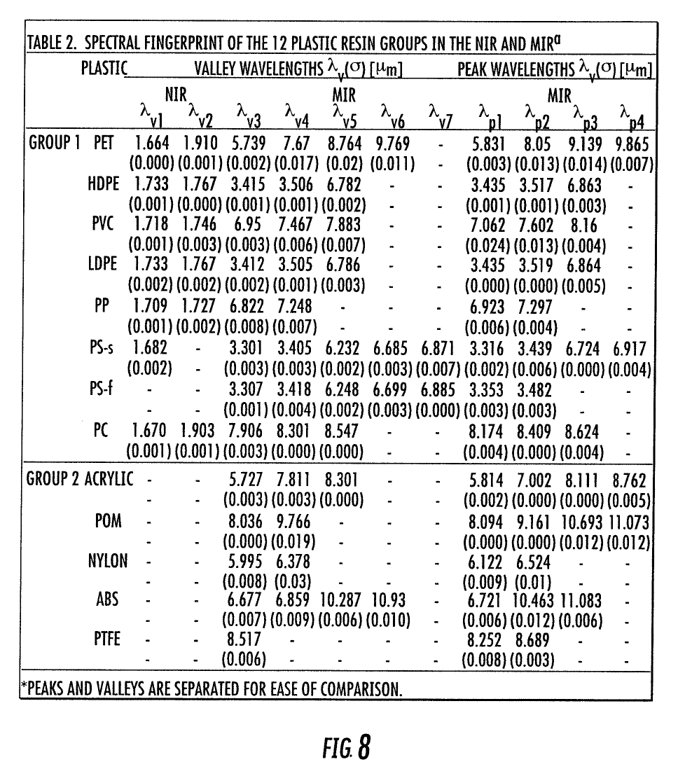

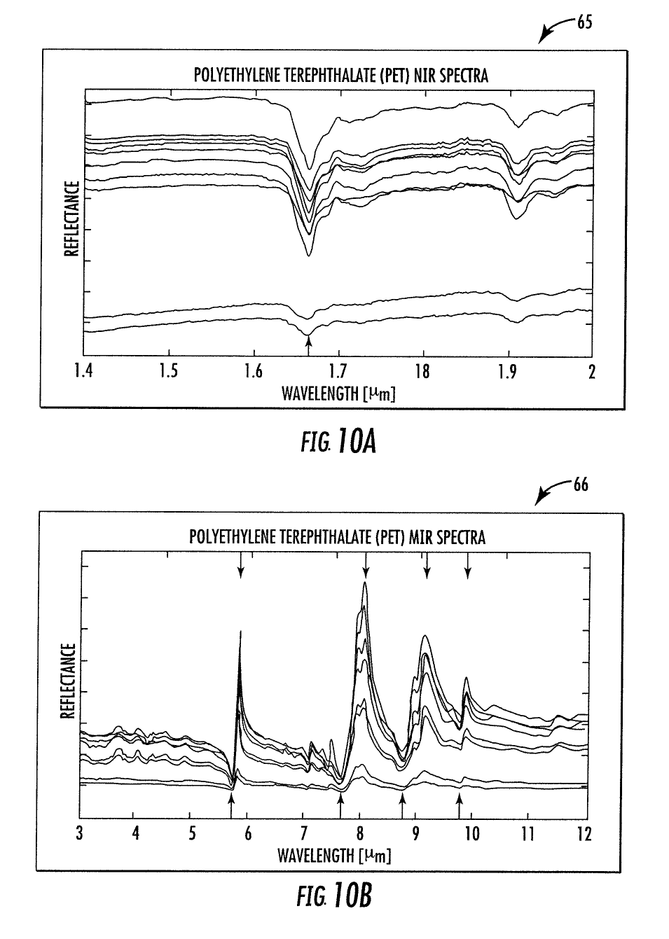

The reflectance spectra were measured for both group 1 and group 2 in the NIR domain. Representative spectra for group (NIR active) are shown in diagram 52 of FIG. 3A (see FIGS. 10A-17B (diagrams 65-80) for more details). The spectral features are determined by the local minima (valleys) in the reflectance spectra that are tabulated in FIG. 8. Diagram 53 of FIG. 3B (see FIGS. 18A-22B (diagrams 81-90) for more detail) shows representative NIR reflectance spectra of plastics contained in group 2 (NIR inactive) showing a constant reflectance without any spectral feature that further vindicates the need for a multi-spectral and multi-dimensional detection approach.

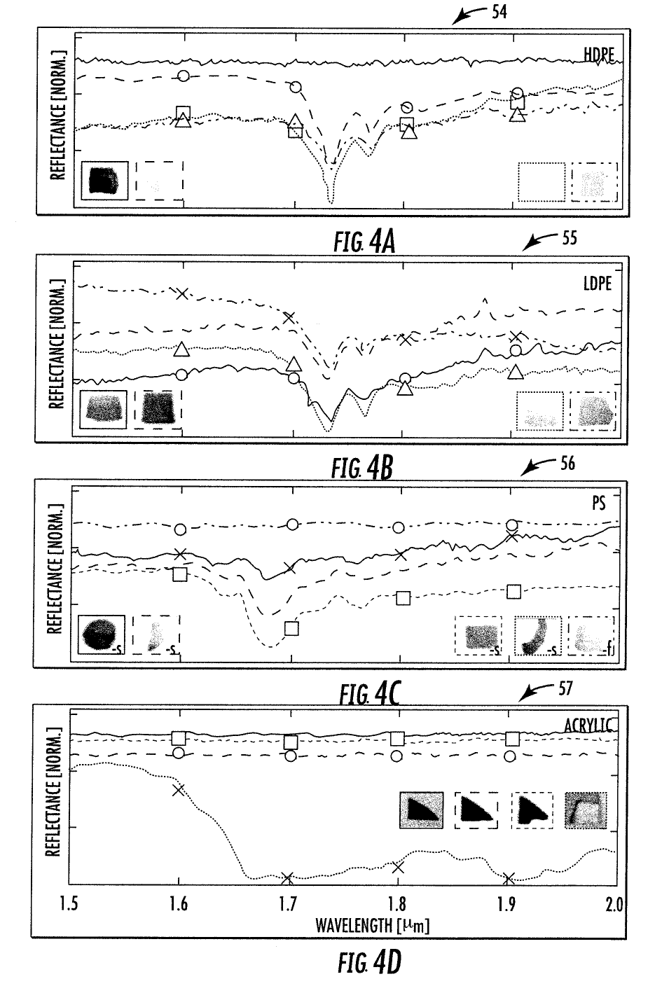

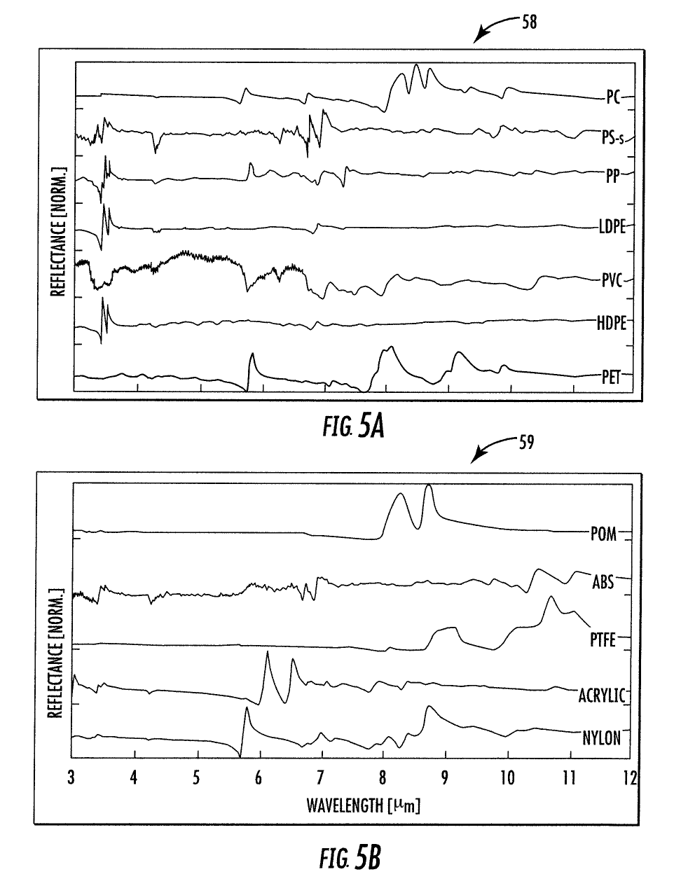

Moreover, the addition of colorants to the base plastic matrix further complicates the detection process. The colorant present in the plastic resin matrix influences, to some extent, the NIR spectra, especially black. In FIG. 4A, diagram 54, four representative spectra of HDPE for black, clear, white, and yellow samples are plotted (actual samples are shown in the inset). In FIG. 4C, diagram 56, the representative spectra of red, clear, blue, and black PS samples (in solid phase) are plotted (actual samples are shown in the inset). All colored HDPE and PS (solid phase) samples have the same spectra, but only the black colored sample lacks NIR activity. In FIG. 4B, diagram 55, four LDPE samples of blue, red, clear, and yellow color are plotted (actual samples are shown in the inset) showing no color variation in the NIR spectra. Colored samples of acrylic samples, on the other hand, are NIR inactive, but the clear sample is NIR active as can be observed in diagram 57 of FIG. 4D (actual samples are shown in the inset).

Other factors that influence the quality of the samples include the surface roughness. From all samples characterized, those having considerable surface roughness displayed very weak reflectance with very shallow resonances almost buried into the noise level. Furthermore, the sample morphology such as PS in solid and foam phases affects the NIR spectra. While solid PS samples (marked as −s) display a distinctive set of spectral features, PS in foam phase (marked as −f) does not show any whatsoever, see FIG. 4C.

From this analysis, it can be observed that the NIR spectroscopy alone is not sufficient for the detection of the complete set of commonly used and specialized plastics with or without color additives.

### Results: Mid-Infrared

The same spectroscopic measurements are performed for both groups in the MIR spectral band. Representative reflectance spectra for groups 1 and 2 are plotted in FIGS. 5A and 5B (diagrams 58-59), respectively (see FIGS. 10A-22B for more detail). In FIGS. 10A-22B, the arrows represent the selected spectral line, peaks and valleys, used to construct the multi-spectral fingerprint library. It can be observed that multiple spectral features in the MIR domain for plastics in group 2, which are NIR inactive. Plastics in group 1 also demonstrate distinct spectral features in the MIR domain (FIG. 5A) that can complement their NIR spectral signatures FIG. 3A.

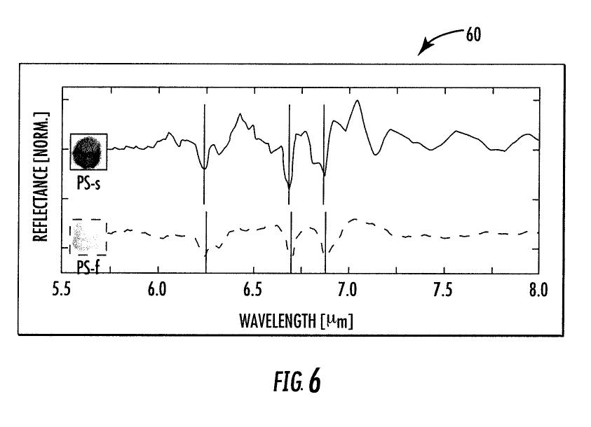

In the NIR domain, the two phases of PS (solid and foam) could not be characterized because solid phase PS samples have spectral features, but not their foam phase counterparts. However, in the MIR domain, both PS phases could be fully characterized but not at the exact resonance features as seen in diagram 60 of FIG. 6. In these morphology dependent spectra, the spectral features (valleys represented by the vertical lines) of PS in foam phase are redshifted with respect to those of PS in solid phase.

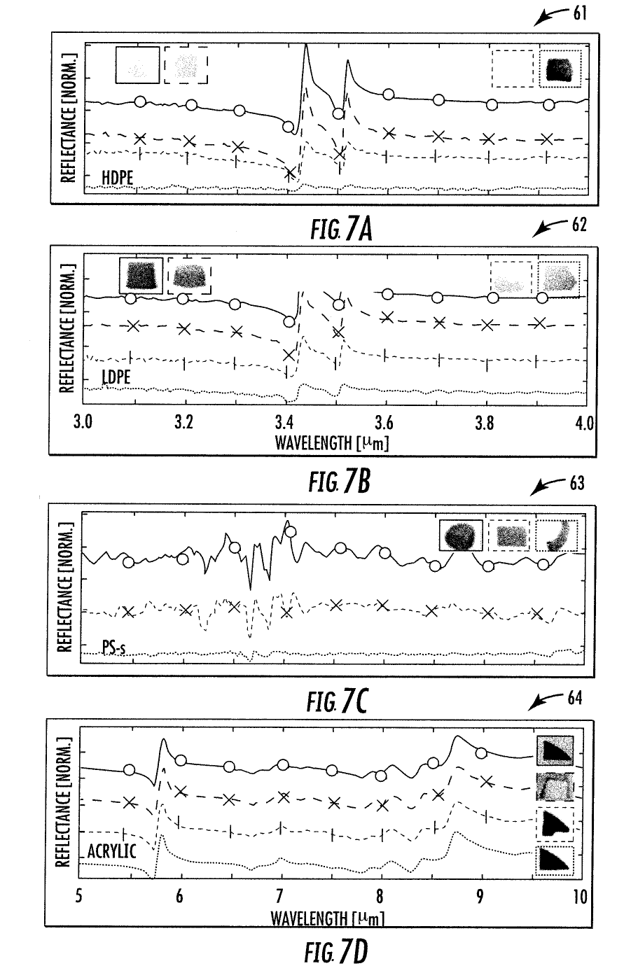

In addition, color does not show significant influence in the reflectance spectra; even black samples can be fully characterized in the MIR domain contrary to the NIR domain. For example, in diagram 61 of FIG. 7A four spectra of colored samples of HDPE are plotted (actual samples are shown in the inset). In that graph, it can be observed that no difference in the spectra for clear, yellow, white, and black colored samples. The relative changes in spectral amplitude originate from the sample surface morphology. The same can be observed in diagram 63 of FIG. 7C for black, red, and blue colors of solid PS samples (actual samples are shown in the inset). In diagram 62 of FIG. 7B, yellow, clear, blue, and red colored samples of LDPE are plotted (actual samples are shown in the inset), having the same color independency spectra. Finally, acrylic samples that had two different NIR spectra, one for colored samples (NIR inactive) and one for a clear sample (see FIG. 4D), are spectrally the same in the MIR domain as seen in diagram 64 of FIG. 7D (actual samples are shown in the inset).

From the full collection of plastics characterized, each plastic resin family had its own set of reflectance features. Due to the diversity in morphology, surface roughness, and thickness among a specific resin family, not all spectra displayed the same spectral features, because of either low reflectance (resonances into the noise level) or no resonances present (resonances associated with specific sample constituent such as fillers). Nevertheless, a set of unique spectral features is present in each plastic resin group. From those features, selected as specified in FIGS. 2A-2B where the arrows represent the selected spectral lines, peaks and valleys, used to construct it, each line with its corresponding standard deviation (λ_{p,v}(c)) is tabulated in FIG. 8 for both the NIR and MIR domains. At least one pair of spectral lines is unique among the 12 sets of plastics that can be used to identify an unknown plastic based on this multi-spectral spectroscopy method. In addition, due to the lack of NIR spectral features for most plastics, it is not practical to incorporate this domain in an actual detection system since the MIR is proved to be sufficient to differentiate any of the 12 plastic resins characterized herein.

One limitation encountered in this method is that HDPE and LDPE cannot be differentiated since their MIR and NIR spectral features are practically the same. In the next section, a blind identification of randomly selected samples from the characterized plastic batch and different plastic objects was carried out to test the validity of the method. Notice that objects matching HDPE or LDPE are identified by polyethylene (PE).

### Blind Detection

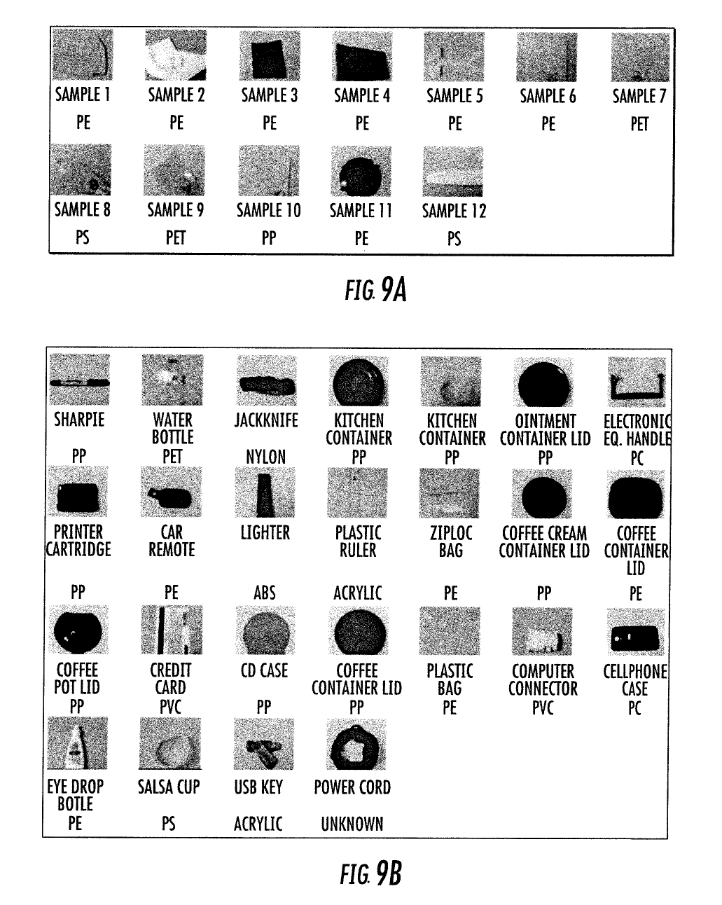

Applicant performed two sets of blind detection experiments of unknown plastics. The first experiment intends to validate the multi-spectral library to identify plastic resins used to construct it. From the collected set of characterized plastics, 12 samples were picked up randomly. They were cut and subject to no surface treatment, such as cleaning. The reflectance spectra were recorded for each sample, and their MIR spectral features were compared to the library. A successful identification is achieved when the spectral features match with all the multi-spectral library lines of a specific resin within the range of the corresponding standard deviation. All samples were successfully identified. FIG. 9A shows the selected plastic samples and the identified resin. The second experiment aimed to validate the multi-spectral library to identify unknown plastic objects. In total 25 objects were tested; see FIG. 9B. Applicant recorded the reflectance spectra and compared them to the MIR spectral features in the library. From the collection 22/25 objects were identified based on the spectral library with high confidence: spectral features falling within the acceptable standard deviation range. Due to the lack of HDPE and LDPE spectral distinction, Applicant used PE to refer to any of its two variations. Two objects, corresponding to the USB key and the salsa cup, were identified as acrylic and PS, respectively, but with low confidence since only half of the spectral features of the sample matched. One object, the power cord, was not identified because its spectral features did not match to the fingerprint of any resin in the library. The power cord is primary made of PVC according to the manufacturer's specifications; however, the presence of fillers in the polymer matrix can modify the spectral response and provided null identification due to the absence of filler material information in the present test library. A modified library that also includes the information various commercial filler materials have in the polymer matrix is needed for such composite plastic identification.

### Conclusions

Twelve plastic resin groups, which are commonly encountered in municipal waste worldwide, are characterized with FTIR reflectance spectroscopy. Based on the NIR and MIR reflectance, Applicant statistically identified the unique spectral features to construct a multi-spectral library covering the IR activity of the characterized plastic resins. Plastics in group 1 are NIR active, but not those in group 2. Furthermore, in the NIR domain there is considerable variation in the reflectance spectra among individuals of the same resin but different colors and morphology, such as the solid and foam phase of PS, the difference in spectra of colored versus clear acrylic, or the lack of spectral features in black samples. Hence the NIR domain, by itself, renders useless for blind identification of samples of the whole resin collection. In the MIR, all plastic resins can be fully characterized including the NIR inactive, those with color, or those that are morphology dependent. The selected spectral features based on peaks and valleys in the reflection spectra add an extra degree of freedom to the identification process. For practical reasons the MIR domain (from 3-12 μm) is enough to identify the whole set of resins as proved in the two blind identification experiments. The only limitation encountered is that LDPE and HDPE cannot be differentiated since their spectral features are the same in both the NIR and MIR domains.

An electronic device is for identifying the plastic composition of an unknown object. The electronic device comprises: a spectrometer configured to receive the unknown object and generate at least one MIR reflectance spectra characteristic of the unknown object; a memory configured to store a database comprising a plurality of plastic types and corresponding pluralities of reflectance spectra characteristics; and a processor coupled to said spectrometer and said memory and configured to identify the plastic composition of the unknown object based upon, but not limited to, comparing the at least one MIR reflectance spectra characteristic with the pluralities of reflectance spectra characteristics.

Each reflectance spectra characteristic comprises a MIR reflectance spectra characteristic. The electronic device wherein the plurality of plastic types comprises PET, HDPE, PVC, LDPE, PP, PS, PC, Acrylic, Nylon, POM, ABS, and PTFE.

A method is for identifying the plastic composition of an unknown object. The method comprises: operating a spectrometer to receive the unknown object and generate at least one MIR reflectance spectra characteristic of the unknown object; operating a memory to store a database comprising a plurality of plastic types and corresponding pluralities of reflectance spectra characteristics; and operating a processor to identify the plastic composition of the unknown object based upon, but not limited to, comparing the at least one MIR reflectance spectra characteristic with the pluralities of reflectance spectra characteristics.

Referring now additionally to FIG. 24, another embodiment of the electronic device 200 is now described. In this embodiment of the electronic device 200, those elements already discussed above with respect to FIG. 23 are incremented by 100 and most require no further discussion herein. This embodiment of the electronic device 200 is also for identifying the plastic composition of an unknown plastic object 205. The electronic device 200 illustratively includes a spectrometer 202 configured to receive the unknown plastic object 205 and generate at least one MIR reflectance spectra characteristic of the unknown plastic object, a memory 201 configured to store a multi-spectral fingerprint library 206 for a plurality of plastic types, and a processor 203 coupled to the spectrometer and the memory. The electronic device 200 illustratively includes an infrared source (e.g. a tungsten filament source and/or a globar source) 204 configured to irradiate the unknown plastic object 205.

The processor 203 is configured to analyze in real-time the at least one MIR reflectance spectra characteristic of the unknown plastic object 205, and identify the plastic composition based upon, but not limited to (i.e. at least), comparing the at least one MIR reflectance spectra characteristic of the unknown plastic object to the multi-spectral fingerprint library 206. In particular, the processor 203 is configured to identify the plastic composition when the at least one MIR reflectance spectra characteristic of the unknown plastic object 205 matches a respective reflectance spectra characteristic in the multi-spectral fingerprint library 206.

In other embodiments, the processor 203 may use other tools (in addition to the MIR reflectance spectra characteristic) to identify the plastic composition of the unknown plastic object 205. For example, the processor 203 may cooperate with an image sensor (not shown) to scan for codes/symbols from the American Section of the International Association (ASTM) International Resin Identification Coding System.

In some embodiments, each reflectance spectra characteristic in the multi-spectral fingerprint library 206 comprises at least one spectral peak and at least one spectral valley associated with a particular vibrational absorption resonance (See, e.g., FIGS. 2A-2B). Each reflectance spectra characteristic in the multi-spectral fingerprint library 206 also comprises at least one standard deviation value for the at least one spectral peak and the at least one spectral valley. The processor 203 is configured to identify the plastic composition when the at least one MIR reflectance spectra characteristic of the unknown plastic object 205 matches each spectral peak and spectral valley of a respective reflectance spectra characteristic in the multi-spectral fingerprint library 206.

Additionally, each reflectance spectra characteristic in the multi-spectral fingerprint library 206 may comprise a MIR reflectance spectral fingerprint. In other embodiments, each reflectance spectra characteristic in the multi-spectral fingerprint library 206 includes a NIR reflectance spectral fingerprint.

For example, the plurality of plastic types may comprise one or more, all, or any subset of PET, HDPE, PVC, LDPE, PP, PS, PC, Acrylic, Nylon, POM, ABS, and PTFE. The detectable plurality of plastic types is not solely limited to the aforementioned group, but to many others with or without fillers or modifiers, which can be straightforwardly added to the library upon initial baseline characterization.

Another aspect is directed to a method for identifying the plastic composition of an unknown plastic object 205. The method may comprise operating a spectrometer 202 to receive the unknown plastic object 205 and generate at least one MIR reflectance spectra characteristic of the unknown plastic object, and operating a memory 201 to store a multi-spectral fingerprint library 206 for a plurality of plastic types. The method may comprise operating a processor 203 coupled to the spectrometer 202 and the memory 201 and to analyze in real-time the at least one MIR reflectance spectra characteristic of the unknown plastic object 205, and identify the plastic composition based upon, but not limited to, comparing the at least one MIR reflectance spectra characteristic of the unknown plastic object to the multi-spectral fingerprint library 206.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

### REFERENCES

1. P. M. Subramanian, “Plastics recycling and waste management in the US,” Resour. Conserv. Recycl. 28, 253-263 (2000).

2. USEPA, Municipal solid waste generation, recycling, and disposal in the United States: facts and figures for 2012 (2014).

3. H. Shent, R. J. Pugh, and E. Forssberg, “A review of plastics waste recycling and the flotation of plastics,” Resour. Conserv. Recycl. 25, 85-109 (1999).

4. J. Hopewell, R. Dvorak, and E. A. Kosior, “Plastics recycling: challenges and opportunities,” Philos. Trans. R. Soc. B 364, 2115-2126 (2009).

5. G. Wu, J. Li, and Z. Xu, “Triboelectrostatic separation for granular plastic waste recycling: a review,” Waste Management 33, 585-597 (2013).

6. G. Dodbiba, A. Shibayama, J. Sadaki, and T. Fujita, “Combination of triboelectrostatic separation and air tabling for sorting plastics from a multicomponent plastic mixture,” Mater. Trans. 44, 2427-2435 (2003).

7. H.-S. Jeon, C.-H. Park, B.-G. Cho, and J.-K. Park, “Separation of PVC and rubber from covering plastics in communication cable scrap by tribocharging,” Sep. Sci. Technol. 44, 190-202 (2009).

8. S. Serranti, V. Luciani, G. Bonifazi, B. Hu, and P. C. Rem, “An innovative recycling process to obtain pure polyethylene and polypropylene from household waste,” Waste Management 35, 12-20 (2015).

9. E. J. Bakker, P. Rem, A. J. Berkhout, and L. Hartmann, “Turning magnetic density separation into green business using the cyclic innovation model,” Open Waste Manage. J. 3, 99-116 (2010).

10. H. Wang, X.-L. Chen, Y. Bai, C. Guo, and L. Zhang, “Application of dissolved air flotation on separation of waste plastics ABS and PS,” Waste Management 32, 1297-1305 (2012).

11. E. Scavino, D. A. Wahab, A. Hussain, H. Basri, and M. M. Mustafa, “Application of automated image analysis to the identification and extraction of recyclable plastic bottles,” J. Zhejiang Univ. Sci. A 10, 794-799 (2009).

12. G. Dodbiba and T. Fujita, “Progress in separating plastic materials for recycling,” Phys. Sep. Sci. Eng. 13, 165-182 (2004).

13. G. Dodbiba, J. Sadaki, and A. Shibayana, “Sorting techniques for plastics recycling,” Chin. J. Process Eng. 6, 186-191 (2006).

14. H. Masoumi, S. M. Safavi, and Z. Khani, “Identification and classification of plastic resins using near infrared reflectance spectroscopy,” World Acad. Sci. Eng. Technol. 6, 141-148 (2012).

15. J. F. Masson, L. Pelletier, and P. Collins, “Rapid FTIR method for quantification of styrene-butadiene type copolymers in bitumen,” J. Appl. Polym. Sci. 79, 1034-1041 (2001).

16. V. Allen, J. H. Kalivas, and R. G. Rodriguez, “Post-consumer plastic identification using Raman spectroscopy,” Appl. Spectrosc. 53, 672-681 (1999).

17. S. Barbier, S. Perrier, P. Freyermuth, D. Perrin, B. Gallard, and N. Gilon, “Plastic identification based on molecular and elemental information from laser induced breakdown spectra: a comparison of plasma conditions in view of efficient sorting,” Spectrochim. Acta B 88, 167-173 (2013).

18. J. Anzano, R.-J. Lasheras, B. Bonilla, and J. Casas, “Classification of polymers by determining of C1:C2:CN:H:N:O ratios by laserinduced plasma spectroscopy (LIPS),” Polym. Test. 27, 705-710 (2008).

19. A. Ulrici, S. Serranti, C. Ferrari, D. Cesare, G. Foca, and G. Bonifazi, “Efficient chemometric strategies for PET-PLA discrimination in recycling plants using hyperspectral imaging,” Chemom. Intell. Lab. Syst. 122, 31-39 (2013).

20. S. Serranti, A. Gargiulo, and G. Bonifazi, “Hyperspectral imaging for process and quality control in recycling plants of polyolefin flakes,” J. Near Infrared Spectrosc. 20, 573-581 (2012).

21. J. M. Chalmers and P. R. Griffiths, Handbook of Vibrational Spectroscopy Vol. 3: Sample Characterization and Spectral Data Processing (Wiley, 2002).

22. V. Lucarini, J. J. Saarinen, K. E. Peiponen, and E. M. Vartiainen, Kramers-Kronig Relations in Optical Materials Research (Springer- Verlag, 2005).

23. M. Claybourn, P. Colombel, and J. Chalmers, “Characterization of carbon-filled polymers by specular reflectance,” Appl. Spectrosc. 45, 279-286 (1991). The content of References 1-23 is hereby incorporated by reference in its entirety.

That which is claimed is:

1. An electronic device for identifying the plastic composition of an unknown plastic object, the electronic device comprising:
a spectrometer configured to receive the unknown plastic object and generate at least one mid-infrared (MIR) reflectance spectra characteristic of the unknown plastic object;
a memory configured to store a multi-spectral fingerprint library for a plurality of plastic types; and
a processor coupled to said spectrometer and said memory and configured to
analyze in real-time the at least one MIR reflectance spectra characteristic of the unknown plastic object, and
identify the plastic composition based upon at least comparing the at least one MIR reflectance spectra characteristic of the unknown plastic object to the multi-spectral fingerprint library.

2. The electronic device of claim 1 wherein said processor is configured to identify the plastic composition when the at least one MIR reflectance spectra characteristic of the unknown plastic object matches a respective reflectance spectra characteristic in the multi-spectral fingerprint library.

3. The electronic device of claim 1 further comprising an infrared source configured to irradiate the unknown plastic object.

4. The electronic device of claim 3 wherein said infrared source comprises at least one of a tungsten filament source and a globar source.

5. The electronic device of claim 1 wherein each reflectance spectra characteristic in the multi-spectral fingerprint library comprises at least one spectral peak and at least one spectral valley.

6. The electronic device of claim 5 wherein each reflectance spectra characteristic in the multi-spectral fingerprint library comprises at least one standard deviation value for the at least one spectral peak and the at least one spectral valley.

7. The electronic device of claim 5 wherein said processor is configured to identify the plastic composition when the at least one MIR reflectance spectra characteristic of the unknown plastic object matches each spectral peak and spectral valley of a respective reflectance spectra characteristic in the multi-spectral fingerprint library.

8. The electronic device of claim 1 wherein the plurality of plastic types comprises Polyethylene Terephthalate (PET), High Density Polyethylene (HDPE), Polyvinyl Chloride (PVC), Low Density Polyethylene (LDPE), Polypropylene (PP), Polystyrene (PS), Polycarbonate (PC), Acrylic, Nylon, Polyoxymethylene (POM), Acrylonitrile Butadiene Styrene (ABS), and Polytetrafluoroethylene (PTFE).

9. An electronic device for identifying the plastic composition of an unknown plastic object, the electronic device comprising:
a spectrometer configured to receive the unknown plastic object and generate at least one mid-infrared (MIR) reflectance spectra characteristic of the unknown plastic object;
an infrared source configured to irradiate the unknown plastic object;
a memory configured to store a multi-spectral fingerprint library for a plurality of plastic types; and
a processor coupled to said spectrometer, said infrared source, and said memory and configured to
analyze in real-time the at least one MIR reflectance spectra characteristic of the unknown plastic object, and
identify the plastic composition based upon at least when the at least one MIR reflectance spectra characteristic of the unknown plastic object matches a respective reflectance spectra characteristic in the multi-spectral fingerprint library, each reflectance spectra characteristic in the multi-spectral fingerprint library comprising at least one spectral peak and at least one spectral valley.

10. The electronic device of claim 9 wherein each reflectance spectra characteristic in the multi-spectral fingerprint library comprises at least one standard deviation value for the at least one spectral peak and the at least one spectral valley.

11. The electronic device of claim 9 wherein said processor is configured to identify the plastic composition when the at least one MIR reflectance spectra characteristic of the unknown plastic object matches each spectral peak and spectral valley of a respective reflectance spectra characteristic in the multi-spectral fingerprint library.

12. The electronic device of claim 9 wherein the plurality of plastic types comprises Polyethylene Terephthalate (PET), High Density Polyethylene (HDPE), Polyvinyl Chloride (PVC), Low Density Polyethylene (LDPE), Polypropylene (PP), Polystyrene (PS), Polycarbonate (PC), Acrylic, Nylon, Polyoxymethylene (POM), Acrylonitrile Butadiene Styrene (ABS), and Polytetrafluoroethylene (PTFE).

13. The electronic device of claim 9 wherein said infrared source comprises at least one of a tungsten filament source and a globar source.

14. A method for identifying the plastic composition of an unknown plastic object, the method comprising:
operating a spectrometer to receive the unknown plastic object and generate at least one mid-infrared (MIR) reflectance spectra characteristic of the unknown plastic object;
operating a memory to store a multi-spectral fingerprint library for a plurality of plastic types; and
operating a processor coupled to the spectrometer and the memory and to
analyze in real-time the at least one MIR reflectance spectra characteristic of the unknown plastic object, and
identify the plastic composition based upon at least comparing the at least one MIR reflectance spectra characteristic of the unknown plastic object to the multi-spectral fingerprint library.

15. The method of claim 14 further comprising operating the processor to identify the plastic composition when the at least one MIR reflectance spectra characteristic of the unknown plastic object matches a respective reflectance spectra characteristic in the multi-spectral fingerprint library.

16. The method of claim 14 further comprising operating an infrared source to irradiate the unknown plastic object.

17. The method of claim 14 wherein each reflectance spectra characteristic in the multi-spectral fingerprint library comprises at least one spectral peak and at least one spectral valley.

18. The method of claim 14 wherein each reflectance spectra characteristic in the multi-spectral fingerprint library comprises at least one standard deviation value for the at least one spectral peak and the at least one spectral valley.

19. The method of claim 14 further comprising operating the processor to identify the plastic composition when the at least one MIR reflectance spectra characteristic of the unknown plastic object matches each spectral peak and spectral valley of a respective reflectance spectra characteristic in the multi-spectral fingerprint library.

20. The method of claim 14 wherein the plurality of plastic types comprises Polyethylene Terephthalate (PET), High Density Polyethylene (HDPE), Polyvinyl Chloride (PVC), Low Density Polyethylene (LDPE), Polypropylene (PP), Polystyrene (PS), Polycarbonate (PC), Acrylic, Nylon, Polyoxymethylene (POM), Acrylonitrile Butadiene Styrene (ABS), and Polytetrafluoroethylene (PTFE).
